(19) United States
(12) Patent Application Publication
(10) Pub. No.: US 2024/0139756 A1
(43) Pub. Date: May 2, 2024

(54) SYSTEM FOR DETECTING AND HANDLING AN OVERLOAD EVENT IN A CRUSHER SYSTEM

(71) Applicant: Metso Outotec Finland Oy, Tampere (FI)

(72) Inventors: Paavo Nieminen, Tampere (FI); Mika Peltonen, Tampere (FI)

(73) Assignee: Metso Outotec Finland Oy, Tampere (FI)

(21) Appl. No.: 18/548,129

(22) PCT Filed: Mar. 9, 2022
(86) PCT No.: PCT/EP2022/056036

§ 371 Date: Aug. 28, 2023

(30) Foreign Application Priority Data
Mar. 12, 2021 (EP) 21162410.1

(51) Int. Cl. B02C 25/00; B02C 2/04; B02C 23/04

(52) U.S. Cl. CPC B02C 25/00; B02C 2/045; B02C 23/04

(57) ABSTRACT

The present invention relates to a system for detecting and handling an overload event in a crusher system. The system comprises a crusher system a crusher for comminution of material. The crusher comprises a clamping arrangement, and a clamping pressure sensor configured to measure a clamping pressure of the clamping arrangement. A processing unit communicatively connectable to the clamping pressure sensor, where the processing unit is configured to output an alarm signal and/or an instruction adjust an operation parameter of the crusher system, based on a received clamping pressure signal.

### FIELD

The present invention relates to a system for detecting and handling an overload event in a crusher system, and to a computer implemented method for detecting and handling an overload event in a system comprising a crusher system.

### BACKGROUND

Crusher used in comminution of material, such as minerals and ores, are expensive and required to be running almost constantly in order to achieve a high efficiency. Therefore, even small down periods can be costly.

Some crushers, such as the cone crushers of the Nordberg HP series made by Metso, are manufactured with a crusher frame. Resting on top of the crusher frame is an adjustment ring for adjusting a setting of the crusher. The adjustment ring is engaged to a crusher bowl of the crusher. The adjustment ring is clamped to the crusher bowl by a clamping arrangement. During operation of such a crusher the adjustment ring is kept in contact with the crusher frame by protective cylinders. However, during an overload event, where the crusher is not able to crush material in the crusher, the protective cylinders allows the adjustment ring to move relative to the crusher frame in order to resolve the overload event.

Even though great efforts have been made to resolve the issues with overload events, there is still a risk of the crusher being damaged during an overload event, because of the large forces involved in crushing of material. Damaging of a crusher during an overload event may lead to down time of the crusher and/or failure of the crusher.

Therefore, it is desirable to minimize the negative effects caused by an overload event.

### SUMMARY

According to a first aspect, the disclosure relates to a system for detecting and handling an overload event in a crusher system, the system comprising a crusher system for comminution of material, the crusher system comprising:
a crusher for comminution of material comprising:
a crusher frame,
a crusher bowl comprising a bowl thread,
an adjustment ring for adjusting a setting of the crusher, where the adjustment ring is configured to go into engagement with the bowl thread,
a clamping arrangement configured to clamp the bowl thread together with the adjustment ring, and
a protective cylinder configured to hold the adjustment ring in contact with the crusher frame, where in an overload event the protective cylinder allows the adjustment ring to move relative to the crusher frame, wherein the system further comprises:
a clamping pressure sensor configured to measure a clamping pressure of the clamping arrangement, and
a processing unit communicatively connectable to the clamping pressure sensor, where the processing unit is configured to:
receive a clamping pressure signal from the clamping pressure sensor,
compare the received clamping pressure signal to a clamping pressure threshold to detect an overload event, and
output an alarm signal and/or an instruction adjusting an operation parameter of the crusher system, if the received clamping pressure signal exceeds the clamping pressure threshold.

Consequently, an automatic and simple system for handling and detecting overload events in a crusher system is provided. An overload event is to be understood as an event, where the crusher is not able to crush material, e.g. because of packing of material, or because of un-crushable material. The crusher may be a cone crusher, a gyratory crusher, or any crusher comprising the abovementioned parts. The clamping pressure sensor may be any sensor capable of measuring a clamping pressure. The processing unit may be communicatively to an external device, e.g. an alarm lamp, loudspeaker, or a smart device. The alarm signal may notify an operator about the detection of an overload event via the external device, e.g. a notification on the smart device, flashing light from an alarm lamp, or an auditory alarm from the loudspeaker. The instruction may be an instruction given to the crusher adjusting an operation parameter of the crusher, e.g. a setting of the crusher. The setting being a crushing gap of the crusher. The instruction outputted may be outputted directly to the crusher system, e.g. to a controller connected to the crusher. The controller being configured to adjust an operation parameter of the crusher. The instruction may also be for an operator, the instruction then instructing the operator on how to adjust the operation parameter. The instruction may be an instruction to gradually change the operation parameter until the received clamping pressure signal does not exceed the clamping pressure threshold, e.g. to gradually increase the setting of the crusher until the overload event is resolved. The processing unit may comprise a data base for logging clamping pressure signals, alarm signals, and/or instructions. The clamping pressure signal contains data indicative of one or more clamping pressures measured by the clamping pressure sensor. The processing unit may also receive a plurality of clamping pressure signals indicative of a plurality of clamping pressures measured by the clamping pressure sensor. Alternatively, the processing unit may receive a plurality of clamping pressure signals continuously during operation of the crusher system.

In an embodiment the crusher system further comprises a feeding system for feeding material to be crushed to the crusher.

Having the crusher system comprises a feeding system allows for the instruction to adjust an operation parameter of the feeding system, e.g. feed speed, stopping feed, or lowering a feed hopper level. The feeding system may comprise one or more conveyor belts for conveying material to the crusher. The feeding system may comprise a feed hopper for feeding material to the crusher.

In an embodiment the clamping pressure threshold is manually adjustable.

The clamping pressure threshold may be adjusted by an on-site operator. Alternatively, an off-site operator may adjust the threshold. The clamping pressure threshold may also be removed by an operator, or additional threshold may be added by an operator. Having the possibility of manually adjusting the clamping pressure threshold gives a larger degree of freedom to an operator of the crusher system, while also allowing the operator's own expertise and knowledge helping in setting the clamping pressure threshold.

In an embodiment the processing unit is further configured to:
receive a clamping pressure signal indicative of a plurality of clamping pressure peaks within a time period,
process the clamping pressure signal received from the clamping pressure sensor to identify clamping pressure peak values,
compare the clamping pressure peak values to a clamping pressure threshold to detect an overload event, and
if more than one clamping pressure peak value exceeds the clamping pressure threshold, output the alarm signal and/or the instruction adjusting an operation parameter of the crusher system.

Having the alarm signal and/or the instruction adjusting an operation parameter of the crusher system being outputted if more than one clamping pressure peak value is above the threshold may assure outliers does not lead an erroneous alarm signals and/or instruction. Furthermore, in some cases if only one clamping pressure peak value exceeding the threshold is detected it may indicate the overload event has resolved by itself, therefore obsoleting the need for the alarm signal and/or the instruction. The clamping pressure peak value exceeding the threshold may be logged by the processing unit, allowing an operator to review the clamping pressure peak value exceeding the threshold. The clamping pressure peak value may be identified by a peak finding algorithm performed by the processing unit. The time period may be set by the processing unit, or the time period may be a continuous time period to allow for continuous monitoring of the crusher system. Alternatively, the time period may be set by an operator of the crusher system. The processing unit may receive a plurality of clamping pressure signals indicative of a plurality of clamping pressures within a time period.

In an embodiment, wherein the crusher system has adjusted the operation parameter based on the instruction by the processing unit, the processing unit is further configured to:
receive a clamping pressure signal indicative of a plurality of clamping pressure peaks within a time period,
process the clamping pressure signal received from the clamping pressure sensor to identify clamping pressure peak values, and
compare the clamping pressure peak values to a clamping pressure threshold, and
if the clamping pressure peak values does not exceed the clamping pressure threshold, output a reverse instruction adjusting the operation parameter to reverse the adjustment by the instruction.

Thus, the system may automatically reverse an operation parameter changed by a prior instruction. Further facilitating a fully automatic system. The reverse instruction may partly or fully reverse the operation parameter. The reverse instruction may be instructions for the adjusted operation parameter to be gradually reversed over time. The processing unit may receive a plurality of clamping pressure signals indicative of a plurality of clamping pressures within a time period.

In an embodiment the processing unit is further configured to:
receive a clamping pressure signals,
analyze the clamping pressure signal to obtain a normal operation clamping pressure of the clamping arrangement, and
set the clamping pressure threshold based on the normal operation clamping pressure of the clamping arrangement.

Thus, the system may be able to perform a simple machine learning algorithm to find a normal operation clamping pressure, further facilitating a fully automatic system. The machine learning algorithm architecture may be trained by evaluating a training data set comprising plurality of training clamping pressures. The plurality of training clamping pressures may be obtained by previous operation of the crusher system. Each of the training clamping pressures may have a score attached to them to indicate whether clamping pressure was associated with desired operation or undesired operation. The score may be assigned by an expert, i.e. the machine learning algorithm may be a supervised learning model. The score may be a binary score e.g. bad/good, or a score on a scale e.g. from 0 to 100. The machine learning algorithm may be based on an artificial neural network such as a deep structured learning architecture. Alternatively, the clamping pressure threshold set based on the normal operation clamping pressure of the clamping arrangement may be set as a clamping pressure exceeding one, two, three, four, or more standard deviations of the normal operation clamping pressure from the normal operation clamping pressure.

In an embodiment the processing unit is further configured to:
compare the received clamping pressure signal to a packing clamping pressure threshold and to a tramp clamping pressure threshold to detect an overload event,
output a packing alarm signal if the packing clamping pressure threshold is exceeded,
output a tramp alarm signal if the tramp clamping pressure threshold is exceeded, and

Having the processing unit either output the tramp alarm signal or the packing alarm signal may help in giving a more accurate assessment of what caused the overload event. The tramp alarm signal and the packing alarm signal preferably leads to different alarms, e.g. the tramp alarm signal leading to a different message being displayed, a different light scheme of an alarm lamp, and/or a different auditory signal than that of the packing alarm signal. The packing clamping pressure and the tramp clamping pressure threshold may have different pressure values. In general, the tramp clamping pressure threshold is higher than the packing clamping pressure threshold. In some embodiments, the processing unit may further be configured to only output the alarm signal related to the highest threshold, if both pressure threshold are exceeded.

In an embodiment the processing unit is further configured to:
output a stop instruction for stopping operation of the crusher system, if the received clamping pressure signal exceeds the clamping pressure threshold.

Stopping operation of crusher may limit and minimize damage to the crusher system caused by an overload event. The stop instruction may stop operation of the whole crusher system or at least part of the crusher system, e.g. if the crusher system comprises a feeding system and a crusher, the stop instruction may stop operation of only the feeding or the crusher or stop operation of both the feeding system and the crusher. The stop instruction in some embodiments, is only outputted if the received clamping pressure threshold exceeds a stop clamping pressure threshold. The stop clamping pressure threshold may be an additional threshold besides the clamping pressure threshold. The stop clamping pressure threshold is preferably a threshold having larger a larger value than the clamping pressure threshold.

In an embodiment the crusher system further comprises a recirculation system for recirculating material through the crusher.

Having the crusher system comprising a recirculation system allows for the instruction to adjust an operation parameter of the recirculation system, e.g. recirculating speed, or stopping recirculation. The recirculation system may comprise one or more conveyor belts for conveying material released by the crusher and through the crusher again, in order to achieve the desired granularity of the material.

In an embodiment the recirculation system comprises one or more material sensor for sensing one or more characteristics of material being recirculated, where the one or more material sensor is communicatively connectable to the processing unit, wherein the processing unit is further configured to:
receive a material signal from the one or more material sensor,

If the received clamping pressure signal exceeds the clamping pressure threshold periodically, process the received material signal to obtain one or more characteristics of material being recirculated, and
based on the one or more characteristics of material being recirculated, either output an alarm signal that a tramp event has occurred or output an alarm signal that a packing event has occurred.

Providing the recirculation system with one or more material sensors may allow for a more precise estimation, whether packing or un-crushable material has caused an overload event. The one or more material sensors may be metal detectors, ultrasound sensors, x-ray sensors, weight sensors, etc. The one or more material sensors may be configured to sense a shape, material type, weight, or material composition of material being recirculated. The material signal received by the processing unit may be a plurality of material signals continuously received during operation of the crusher system. Alternatively, the processing unit may receive a plurality of material signals only received for a set time period subsequent to a clamping pressure signal exceeding the clamping pressure threshold. If this plurality of material signals returns periodically, it could be a sign of recirculating tramp material or similar. The material signal may also only be single material signal giving a snapshot of one or more characteristics of material being recirculated. The processing unit may be configured to process a plurality of material signals over a set period of time, to accommodate for the time delay between the overload event and the material causing the overload event passing the material sensor. The processing unit may be configured to firstly output the instruction for adjusting the operation parameter of the crusher system, and subsequently process the material signal and based on the obtained one or more characteristics of material being recirculated, output an alarm signal. The processing unit may be configured to output the tramp alarm signal if metal is detected in the material being recirculated, or to output the packing alarm signal if no metal is detected in the material being recirculated.

According to a second aspect, the invention relates to a computer implemented method for detecting and handling an overload event in a system comprising a crusher system, the crusher system comprising a crusher, where the crusher comprises a crusher frame, a crusher bowl comprising a bowl thread, an adjustment ring for adjusting a setting of the crusher, where the adjustment ring is configured to go into clamping engagement with the bowl thread, a clamping arrangement configured to clamp the bowl thread together with the adjustment ring, and a protective cylinder configured to hold the adjustment ring in contact with the crusher frame, where in an overload event the protective cylinder allows the adjustment ring to move relative to the crusher frame, and wherein the system further comprises a clamping pressure sensor configured to measure a clamping pressure of the clamping arrangement, where the method comprises the steps of:
receiving a clamping pressure signal from the clamping pressure sensor, wherein the clamping pressure signal is indicative of one or more clamping pressures measured by the clamping pressure sensor,
comparing the received clamping pressure signal to a clamping pressure threshold, and
outputting an alarm signal and/or an instruction adjusting an operation parameter of the crusher system, if the received clamping pressure signal exceeds the clamping pressure threshold.

The different aspects of the present invention can be implemented in different ways described above and in the following, each yielding one or more of the benefits and advantages described in connection with at least one of the aspects described above, and each having one or more preferred embodiments corresponding to the preferred embodiments described in connection with at least one of the aspects described above and/or disclosed in the dependent claims.

Furthermore, it will be appreciated that embodiments described in connection with one of the aspects described herein may equally be applied to the other aspects.

### BRIEF DESCRIPTION OF THE DRAWINGS

The above and/or additional objects, features, and advantages of the present invention, will be further elucidated by the following illustrative and non-limiting detailed description of embodiments of the present invention, with reference to the appended drawings, wherein:

FIG. 1 shows a partial cross-sectional view of a crusher according to the invention.

FIG. 2 which depicts a graph showing clamping pressure exerted by a clamping pressure device over time.

FIG. 3 depicts a block diagram of communication within a crusher system according to a first embodiment of the invention.

FIG. 4 depicts a block diagram of communication within a crusher system according to a second embodiment of the invention.

FIG. 5 depicts a flow diagram of steps performed by the processing unit according to an embodiment of the invention.

FIG. 6 depicts a flow diagram of steps performed by the processing unit according to an embodiment of the invention.

FIG. 7 depicts a flow diagram of steps performed by the processing unit according to an embodiment of the invention.

FIG. 8 depicts a flow diagram of steps performed by the processing unit according to an embodiment of the invention.

FIG. 9 depicts a flow diagram of steps performed by the processing unit according to an embodiment of the invention.

FIG. 10 depicts a flow diagram of steps performed by the processing unit according to an embodiment of the invention.

### DETAILED DESCRIPTION

In the following description, reference is made to the accompanying figures, which show by way of illustration how the invention may be practiced.

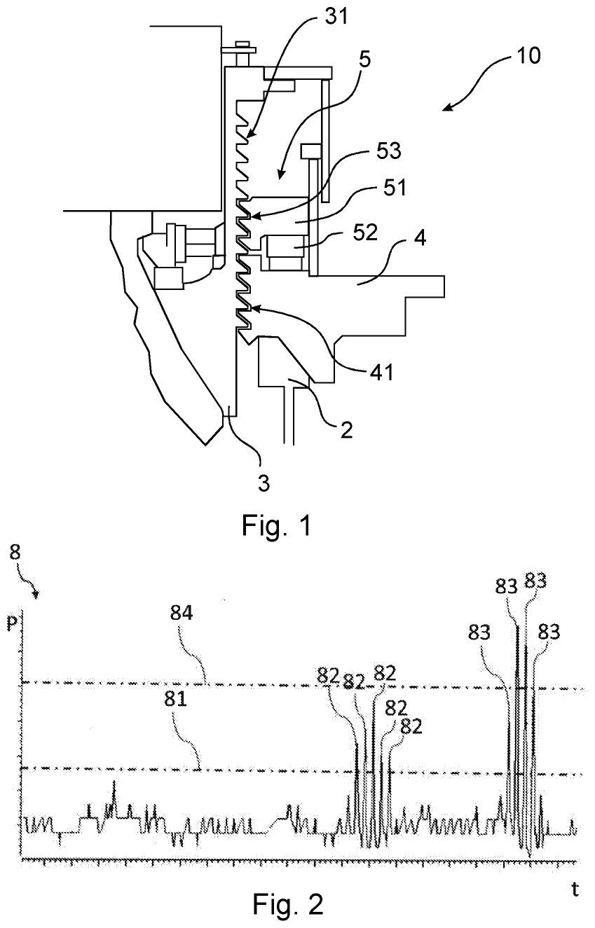

Referring initially to FIG. 1, which shows a partial cross-sectional view of a crusher 10. The crusher 10 comprises a frame 2. Lying on the frame 2 is an adjustment ring 4. The adjustment 4 is for adjusting a setting of the crusher 10, i.e. for adjusting a crushing gap of the crusher 10. The adjustment ring 4 is in normal operation, i.e. comminution of material being fed to the crusher 4, held connected to the frame 2 by protective cylinders, not shown. The adjustment ring 4 comprises an adjustment ring thread 41. The adjustment ring thread 41 may preferably be a buttress thread 41 having a load bearing thread face perpendicular to the screw axis and oriented towards a first direction. The adjustment ring thread 41 is in engagement with a bowl thread 31 of a crusher bowl 3. The bowl thread 31 may preferably be a buttress thread 31 having a load bearing thread face perpendicular to the screw axis and oriented towards a second direction, which is opposite the first direction. The engagement between the bowl thread 31 and the adjustment ring thread 41 allows for the setting of the crusher to be adjusted by rotation of the adjustment ring 4 around the screw axis. The adjustment ring 4 and the bowl thread 31 are in normal operation clamped together by a clamping arrangement 5. The clamping arrangement 5 comprises a clamping ring 51. The clamping ring comprises a clamping thread 53 in engagement with the bowl thread 31. The clamping thread 53 may preferably be a buttress thread 53 having a load bearing thread face perpendicular to the screw axis and oriented towards the first direction. The clamping arrangement 5 further comprises a clamping pressure device 52. The clamping pressure device 52 is arranged in-between and directly connected to the clamping ring 51 and the adjustment ring 4. The clamping pressure device 52 can exert a clamping pressure onto the adjustment ring 4 or both the adjustment ring 4 and the clamping ring 51. The clamping pressure exerted by the clamping pressure device 52 results in the adjustment ring thread 41 being clamped together with the bowl thread 31. The clamping pressure device 52 may be a clamping cylinder or a clamping bladder. During operation of the crusher 10 the clamping pressure device 52 moves together with the adjustment ring 4.

During overload events, e.g. packing of material or uncrushable material being introduced in the feed, the protective cylinders holding the adjustment ring 4 against the frame 2 allows for the adjustments ring 4 to move up and away from the frame 2. The upwards movement of the adjustment ring 4 results in an increased setting, which in return allows for the overload event to be resolved, e.g. by allowing packed and/or uncrushable material to pass through the crusher 10. During the upward movement of the adjustment ring 4, the crusher bowl 3 moves together with the adjustment ring as they are clamped together. After the upwards movement, the protective cylinders pull down the adjustment ring 4 towards the frame 2, this results in the adjustment ring 4 hitting the frame 2. The hit between the adjustment ring 4 and the frame 2 results in a mechanical shock. The applicant has discovered that this mechanical shock can be detected by monitoring the clamping pressure exerted by the clamping pressure device 52.

Referring to FIG. 2, which depicts a graph 8 showing clamping pressure exerted by the clamping pressure device 52 over time. During normal operation of the crusher 10 it is seen that the clamping pressure is kept below a first threshold 81. Because of overload events it is seen that sharp clamping pressure peaks 82, and 83 appear, with a maximum clamping pressure exceeding the first threshold 81. The sharp clamping pressure peaks 82, and 83 are a result of the mechanical shock created by the hit between the frame 2 and the adjustment ring 4. Therefore, these clamping pressure peaks 82, and 83 can be used for detecting that an overload event has taken place. The first threshold 81 may be set manually by an operator giving an input to a processing unit 7. The first threshold 81 may alternatively be set automatically by the processing unit 7. In the shown embodiment the first thresholds 81 and a second threshold 84 are applied. The different threshold may be indicative of different events. For example, the applicant has noticed that the pressure peaks associated with a tramp event are of a higher magnitude than the pressure peaks associated with a packing event. To accommodate for this, different thresholds 81, 84 may be set which are indicative of different events. In the graph 8, the first threshold 81 is a packing clamping pressure threshold 81 indicative of a packing event and the second threshold is a tramp clamping pressure threshold 84 indicative of a tramp event.

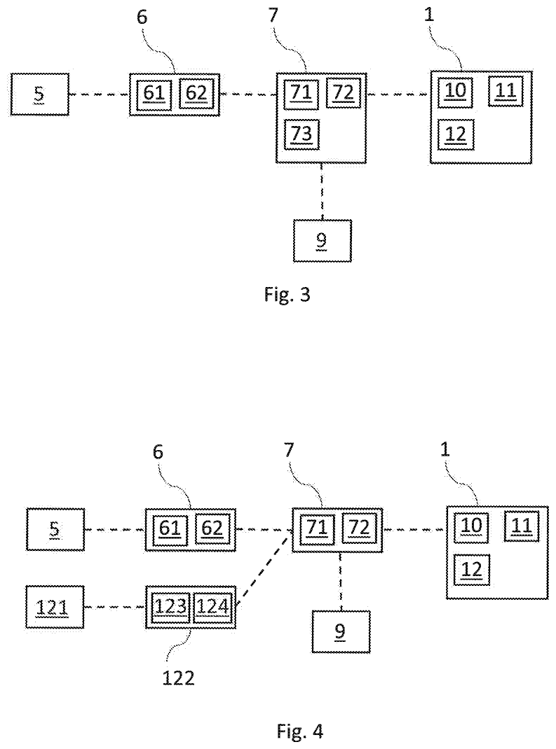

Referring to FIG. 3, which depicts a block diagram of communication within a crusher system 1 according to a first embodiment of the invention. The system 1 comprises the clamping arrangement 5. In connection with the clamping arrangement 5 is a clamping pressure sensor 6 configured to measure a clamping pressure of the clamping arrangement 5. The clamping pressure sensor 6 comprises a measuring device 61 configured to measure a clamping pressure of the clamping arrangement 5. The clamping pressure sensor 6 further comprises a sensor transmitter 62 configured for transmitting the measured clamping pressure as a clamping pressure signal to a processing unit 7. The processing unit 7 comprises internal logic 72 for processing a received clamping pressure signal. The internal logic 72 may be general purpose or proprietary programmable microprocessors, such as Digital Signal Processors (DSP), Application Specific Integrated Circuits (ASIC), Programmable Logic Arrays (PLA), Field Programmable Gate Arrays (FPGA), special-purpose electronic circuits, etc., or a combination thereof. The processing unit 7 further comprises a transceiver 71 for receiving the clamping pressure signal and to transmit an alarm signal and/or an instruction for adjusting an operation parameter of the crusher system 1. The processing unit 7 may further comprise a database 73 for logging received clamping pressure signals and/or alarm signals and/or instructions for adjusting an operation parameter of the crusher system 1. The processing unit 7 may transmit an alarm signal to an external device 9. The external device 9 may be a user device such as a tablet, a personal computer, a mobile terminal, or a display. The external device 9 may be configured to display the alarm signal on a display. The external device 9 may also be an alarm lamp or a loudspeaker capable of producing a sensory signal in response to receiving the alarm signal. The processing unit 7 may be configured for outputting instructions for adjusting an operation parameter of the crusher system 1. The crusher system may comprise the crusher 10, a feeding system 11, and/or a recirculation system. The feeding system 11 being for feeding material to be crushed to the crusher 10. The feeding system 11 may be one or more conveyor belts. The feeding system 11 preferably comprises a feed hopper. The recirculation system 12 being for recirculating material through the crusher 10, e.g. if additional crushing of the material is needed. The recirculation system 12 may be one or more conveyor belts. The recirculation system 12 may be connected to feeding system 11 via one or more conveyor belts. The instruction transmitted by the processing unit 7 may be received by a receiver in the crusher 10, the feeding system 10, and/or the recirculation system. The instruction being for adjusting an operation parameter of the crusher system 1. The operation parameter of the crusher system 1 may be one or any combination of the following: a crusher setting, a feed speed of the feeding system 11, a recirculation speed of the recirculation system 12, stopping the feed of material to the crusher, or a feed hopper level.

Referring to FIG. 4, which depicts a block diagram of communication within a crusher system 1 according to a second embodiment of the invention. The second embodiment may comprise the same components as the first embodiment. The second embodiment differing from the first embodiment in that, the recirculation system 12 comprises comprises one or more material sensors 122 for sensing one or more characteristics of material 121 being recirculated. The one or more characteristics may be weight, shape, density, or material type. The one or more material sensors 122 are communicatively connectable to the processing unit 7. The one or more material sensors 122 may comprise a material measuring device 123 configured to measure a characteristic of material being recirculated. The one or more materials sensors 122 further comprises a material sensor transmitter 62 configured for transmitting the measured clamping pressure as a clamping pressure signal to a processing unit 7. By combining the sensor input from the one or more material sensors 122 and the clamping pressure sensor 6 a more precise estimation, whether an in-crushable material or a packing material have caused an overload event may be achieved.

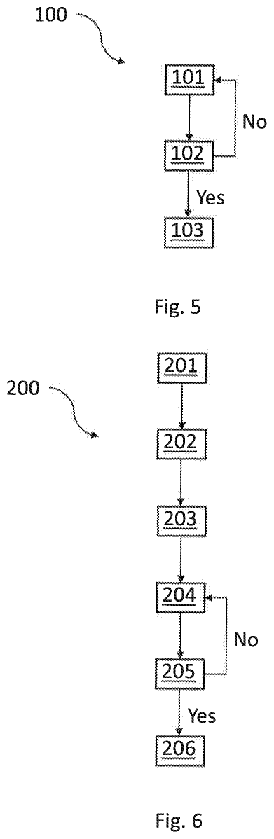

Referring to FIG. 5, which depicts a flow diagram 100 of steps performed by the processing unit 7 according to an embodiment of the invention. In a first step 101 the processing unit 7 receives a clamping pressure signal from the clamping pressure sensor 6. In a second step the received clamping pressure signal is compared to a threshold 81, in order to detect whether an overload event has occurred. The threshold 81 may be set manually by an operator giving an input to the processing unit 7. The input may be given by an operator via the external device 9. Alternatively, the threshold 81 may be set automatically by the processing unit 7. If the received clamping pressure signal exceeds the clamping pressure threshold 81, the processing unit 7 is in a third step 103 configured to output an alarm signal and/or an instruction adjusting an operation parameter of the crusher system 1. If the received clamping pressure signal does not exceed the clamping pressure threshold 81, the processing unit 7 returns to the first step 101.

Referring to FIG. 6, which depicts a flow diagram 200 of steps performed by the processing unit 7 according to an embodiment of the invention. In a first step 201 the processing unit receives a clamping pressure signal indicative of a plurality of clamping pressures. The clamping pressure signal may be provided by the clamping pressure sensor 6. The plurality of clamping pressures may be provided as inputs from the external device 9 to the processing unit 7. The clamping pressure signal may be stored in the database 73 of the processing unit. In a second step 202 the processing unit 7 analyzes the received clamping pressure signal to obtain a normal operation clamping pressure of the clamping arrangement 5. The normal operation clamping pressure corresponding to a clamping pressure value or a clamping pressure interval exerted by the clamping arrangement during normal operation of the crusher 10. In a third step 203 the processing unit sets the clamping pressure threshold based on the normal operation clamping pressure of the clamping arrangement 5. The clamping pressure threshold may be set as a value exceeding normal operation clamping pressure of the clamping arrangement 5. In a fourth step 204 the processing unit 7 receives a clamping pressure signal from the clamping pressure sensor 6. In a fifth step 205 the received clamping pressure signal is compared to the clamping pressure threshold 81 set by the processing unit, in order to detect whether an overload event has occurred. If the received clamping pressure signal exceeds the clamping pressure threshold 81, the processing unit 7 is in a sixth step 206 configured to output the alarm signal and/or the instruction adjusting an operation parameter of the crusher system 1. If the received clamping pressure signal does not exceed the clamping pressure threshold 81, the processing unit 7 returns to the fourth step 204.

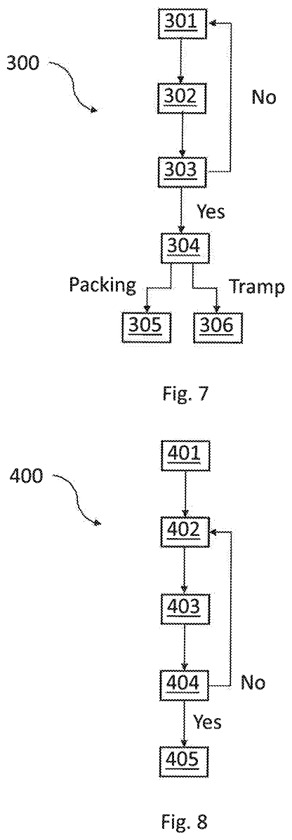

Referring to FIG. 7, which depicts a flow diagram 300 of steps performed by the processing unit 7 according to an embodiment of the invention. In a first step 301 the processing unit 7 receives a clamping pressure signal from the clamping pressure sensor 6. In a second step 302 a material signal is received by the processing unit 7 from the one or more material sensors 122. In a third step 303 the received clamping pressure signal is compared to a threshold 81, in order to detect whether an overload event has occurred. If the received clamping pressure signal does not exceed the clamping pressure threshold 81, the processing unit 7 returns to the first step 301. If the received clamping pressure signal exceeds the clamping pressure threshold 81, the processing unit 7 is in a fourth step 304 configured to process the received material signal to obtain one or more characteristics of material being recirculated. Based on the one or more characteristics of material being recirculated, the processing unit may either in fifth step 305 output an alarm signal that a tramp event has occurred, or in a sixth step output an alarm signal that a packing event has occurred. The process in the fourth step 304 made may for example be to check if the material sensors 122 has detected metal within the material of the recirculation system 12. The presence of metal may indicate a tramp event has occurred and prompt and processing unit to output an alarm signal that a tramp event has occurred, or if no metal was detected, this may indicate a packing event has occurred, and prompt the processing unit 7 to output an alarm signal that a packing event has occurred.

Referring to FIG. 8, which depicts a flow diagram 400 of steps performed by the processing unit 7 according to an embodiment of the invention. In a first step 401 the processing unit 7 sets a time period. The time period may be any period of time, e.g. 30-60 seconds, or 10-120 seconds. Alternatively, the time period may be set as continuously time period. The time period may be set based on parameters of the crusher system 1, e.g. a time period may correspond to a recirculation time of material through the recirculation system 12, or the time period may be set based on a feed speed of the feeding system 11. In a second step 402 the processing unit receives a clamping pressure signal from the clamping pressure sensor indicative of measured clamping pressures within the set time period. Thus, the amount of clamping pressures received may depend on the sampling rate of the clamping pressure sensor and the set time period. In a third step 403 the processing unit 7 processes the clamping pressure signal received from the clamping pressure sensor to identify clamping pressure peak values. The processing unit may use known peak finding algorithms for identifying peaks within the measured clamping pressures. In a fourth step 404 the processing unit 7 compares the clamping pressure peak values to a clamping pressure threshold to detect an overload event. If more than one clamping pressure peak values exceed the clamping pressure threshold, the processing unit 7 outputs in a fifth step 405 the alarm signal and/or the instruction adjusting an operation parameter of the crusher system. The amount of clamping pressure peak values needed to exceed the clamping pressure threshold in order for the processing unit 7 to output the alarm signal and/or the instruction, may be two, three, four, five, or more. By needing at least more than one clamping pressure peak value to exceed the clamping pressure threshold, it may assure measurement outliers does not lead to erroneous instructions and/or alarm signals.

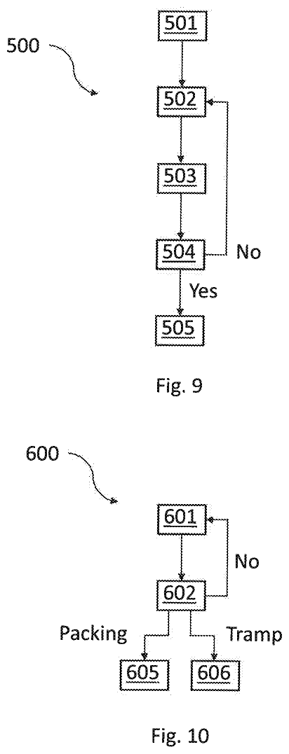

Referring to FIG. 9, which depicts a flow diagram 500 of steps performed by the processing unit 7 according to an embodiment of the invention. In the embodiment shown on FIG. 9, the crusher system 10 has already adjusted an operation parameter based on an instruction by the processing unit 7. In a first step 501 the processing unit 7 sets a time period. The time period may be any period of time, e.g. 30-60 seconds, or 10-120 seconds. Alternatively, the time period may be set as continuously time period. The time period may be set based on parameters of the crusher system 1, e.g. a time period may correspond to a recirculation time of material through the recirculation system 12, or the time period may be set based on a feed speed of the feeding system 11. In a second step 502 the processing unit receives a clamping pressure signals from the clamping pressure sensor indicative of a plurality of clamping pressures within the set time period. Thus, the amount of clamping pressures received may depend on the sampling rate of the clamping pressure sensor and the set time period. In a third step 503 the processing unit 7 processes the clamping pressure signal received from the clamping pressure sensor to identify clamping pressure peak values. The processing unit may use known peak finding algorithms for identifying peaks within the clamping pressure signal. In a fourth step 504 the processing unit 7 compares the clamping pressure peak values to a clamping pressure threshold to detect an overload event. If the clamping pressure peak values does not exceed the clamping pressure threshold, the processing unit 7 in a fifth step 505 outputs a reverse instruction adjusting the operation parameter to reverse the adjustment by the instruction. The reverse instruction may be a reverse instruction reversing or at least partly reversing an operation parameter, which have been adjusted by the processing unit, e.g. if a setting of the crusher 10 has been increased as a consequence of an instruction outputted by the processing unit 7, the reverse instruction may be to fully or partly revert the setting of the crusher 10.

Referring to FIG. 10, which depicts a flow diagram 600 of steps performed by the processing unit 7 according to an embodiment of the invention. In a first step 601 the processing unit 7 receives a clamping pressure signal from the clamping pressure sensor 6. In a second step 602 the processing unit 7 compares the received clamping pressure signal to a packing clamping pressure threshold and to a tramp clamping pressure threshold to detect an overload event. The packing clamping pressure threshold is a clamping pressure threshold associated with an overload event caused by packing of material in the crusher 10. The tramp clamping pressure threshold is a clamping pressure threshold associated with an overload event caused by uncrushable material in the crusher 10. The tramp clamping pressure threshold and the packing clamping pressure threshold differs from each other. The tramp clamping pressure threshold and the packing clamping pressure threshold may be set manually by an operator or automatically by the processing unit 7. if the packing clamping pressure threshold is exceeded, the processing unit in a fifth step 605 outputs a packing alarm signal. The packing alarm signal is a signal indicative of that the overload event, which have happened was caused by packing of material. If the tramp clamping pressure threshold is exceeded, the processing unit in a sixth step 606 outputs a tramp alarm signal. The tramp alarm signal is a signal indicative of that the overload event, which have happened was caused by in-crushable material. If both the packing clamping pressure threshold and the tramp clamping pressure threshold is exceeded, the processing unit 7 may choose to only output the alarm signal associated with the highest threshold.

Although some embodiments have been described and shown in detail, the invention is not restricted to them, but may also be embodied in other ways within the scope of the subject matter defined in the following claims. In particular, it is to be understood that other embodiments may be utilized, and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A system for detecting and handling an overload event in a crusher system, the system comprising a crusher system for comminution of material, the crusher system comprising:
a crusher for comminution of material comprising:
a crusher frame,
a crusher bowl comprising a bowl thread,
an adjustment ring for adjusting a setting of the crusher, where the adjustment ring is configured to go into engagement with the bowl thread,
a clamping arrangement configured to clamp the bowl thread together with the adjustment ring, and
a protective cylinder configured to hold the adjustment ring in contact with the crusher frame, where in an overload event the protective cylinder allows the adjustment ring to move relative to the crusher frame, wherein the system further comprises:
a clamping pressure sensor configured to measure a clamping pressure of the clamping arrangement, and
a processing unit communicatively connectable to the clamping pressure sensor, where the processing unit is configured to:
receive a clamping pressure signal from the clamping pressure sensor, wherein the clamping pressure signal is indicative of one or more clamping pressures measured by the clamping pressure sensor,
compare the received clamping pressure signal to a clamping pressure threshold to detect an overload event, and
output an alarm signal and/or an instruction adjusting an operation parameter of the crusher system, if the received clamping pressure signal exceeds the clamping pressure threshold.

2. The system according to claim 1, wherein the crusher system further comprises a feeding system for feeding material to be crushed to the crusher.

3. The system according to claim 1, wherein the clamping pressure threshold is manually adjustable.

4. The system according to claim 1, wherein the processing unit is further configured to:
receive a clamping pressure signal indicative of a plurality of clamping pressure peaks within a time period,
process the clamping pressure signal received from the clamping pressure sensor to identify clamping pressure peak values,
compare the clamping pressure peak values to a clamping pressure threshold to detect an overload event, and
if one or more of the clamping pressure peak values exceeds the clamping pressure threshold, output the alarm signal and/or the instruction adjusting an operation parameter of the crusher system.

5. The system according to claim 1, wherein the crusher system has adjusted the operation parameter based on the instruction by the processing unit, the processing unit is further configured to:
receive a clamping pressure signal indicative of a plurality of clamping pressure peaks within a time period,
process the clamping pressure signal received from the clamping pressure sensor to identify clamping pressure peak values, and
compare the clamping pressure peak values to a clamping pressure threshold, and
if the clamping pressure peak values does not exceed the clamping pressure threshold, output a reverse instruction adjusting the operation parameter to reverse the adjustment by the instruction.

6. The system according to claim 1, wherein the processing unit is further configured to:
receive a clamping pressure signal,
analyze the received clamping pressure signals to obtain a normal operation clamping pressure of the clamping arrangement, and
set the clamping pressure threshold based on the normal operation clamping pressure of the clamping arrangement.

7. The system according to claim 1, wherein the processing unit is further configured to:
compare the received clamping pressure signal to a packing clamping pressure threshold and to a tramp clamping pressure threshold to detect an overload event,
output a packing alarm signal if the packing clamping pressure threshold is exceeded, and
output a tramp alarm signal if the tramp clamping pressure threshold is exceeded., and

8. The system according to claim 1, wherein the processing unit is further configured to:
output a stop instruction for stopping operation of the crusher system, if the received clamping pressure signal exceeds the clamping pressure threshold.

9. The system according to claim 1, wherein the crusher system further comprises a recirculation system for recirculating material through the crusher.

10. The system according to claim 9, wherein the recirculation system comprises one or more material sensor for sensing one or more characteristics of material being recirculated, where the one or more material sensor is communicatively connectable to the processing unit, wherein the processing unit is further configured to:
receive a material signal from the one or more material sensor,
If the received clamping pressure signal exceeds the clamping pressure threshold periodically, process the received material signal to obtain one or more characteristics of material being recirculated, and
based on the one or more characteristics of material being recirculated, either output an alarm signal that a tramp event has occurred or output an alarm signal that a packing event has occurred.

11. A computer implemented method for detecting and handling an overload event in a system comprising a crusher system, the crusher system comprising a crusher, where the crusher comprises a crusher frame, a crusher bowl comprising a bowl thread, an adjustment ring for adjusting a setting of the crusher, where the adjustment ring is configured to go into clamping engagement with the bowl thread, a clamping arrangement configured to clamp the bowl thread together with the adjustment ring, and a protective cylinder configured to hold the adjustment ring in contact with the crusher frame, where in an overload event the protective cylinder allows the adjustment ring to move relative to the crusher frame, and wherein the system further comprises a clamping pressure sensor configured to measure a clamping pressure of the clamping arrangement, where the method comprises the steps of:
receiving a clamping pressure signal from the clamping pressure sensor, wherein the clamping pressure signal is indicative of one or more clamping pressures measured by the clamping pressure sensor,
comparing the received clamping pressure signal to a clamping pressure threshold, and
outputting an alarm signal and/or an instruction adjusting an operation parameter of the crusher system, if the received clamping pressure signal exceeds the clamping pressure threshold.
